(19) United States
(12) Patent Application Publication
(10) Pub. No.: US 2026/0242223 A1
(43) Pub. Date: Aug. 20, 2026

(54) METHOD FOR OBTAINING XENON USING A MOLECULAR SIEVE

(71) Applicant: LINDE GMBH, Pullach (DE)

(72) Inventors: Matthias GRAHL, Pullach (DE); Matthias MEILINGER, Pullach (DE)

(21) Appl. No.: 18/859,449

(22) PCT Filed: Apr. 12, 2023
(86) PCT No.: PCT/EP2023/025169

§ 371 Date: Oct. 23, 2024

(30) Foreign Application Priority Data
Apr. 28, 2022 (EP) 22020191.7

(51) Int. Cl. C01B 23/00

(52) U.S. Cl. CPC C01B 23/0068

(57) ABSTRACT

The invention relates to a method for obtaining xenon, wherein a first feed flow containing xenon and sulfur hexafluoride is supplied to a rectification step, and a first subsequent flow is formed by means of the rectification step, said subsequent flow containing xenon and being enriched with sulfur hexafluoride in comparison with the first feed flow, wherein at least a part of the first subsequent flow is subjected to an adsorption step as a second feed flow, and a second subsequent flow is formed by means of the adsorption step, said second subsequent flow containing xenon and being depleted of sulfur hexafluoride in comparison with the feed mixture The present invention also relates to a corresponding system.

The invention relates to a method and a system for obtaining xenon.

### BACKGROUND OF THE INVENTION

The noble gases krypton and xenon, which are present in the air in amounts of approximately 1 ppm and 0.09 ppm, respectively, can be obtained by converting considerable quantities of air in air separation systems. The boiling points of krypton and xenon are 120 K and 165 K, respectively, i.e., far above the boiling temperatures of nitrogen, oxygen, and the other noble gases. Krypton and xenon therefore accumulate in the liquid oxygen together with various hydrocarbons in the usual double column rectifiers.

To obtain krypton and xenon, some of the liquid oxygen enriched with krypton and xenon can be taken from the main condenser and fed into a krypton enrichment column. The enrichment column then produces a so-called krypton-xenon concentrate, which contains approximately 1% krypton, 0.5% hydrocarbons and 0.1% xenon. The main component is oxygen.

The concentrate obtained in the krypton enrichment column can be evaporated under supercritical pressure, heated to approx. 500° C. and passed over a catalyst, wherein the hydrocarbons are decomposed into water vapor and carbon dioxide, and nitrous oxide can also be converted into nitrogen and oxygen on the catalyst. The water vapor and carbon dioxide can be adsorptively removed from the concentrate using molecular sieves. In a subsequent distillation column, the oxygen can be removed overhead, and a highly enriched krypton-xenon concentrate can be obtained. In a subsequent krypton-xenon rectification, krypton and xenon can then be separated from one another.

When krypton and xenon are obtained as described in cryogenic air separation systems, krypton and xenon are highly enriched. The disadvantage here is that trace impurities in the air are also enriched. These include mainly fluorocarbons and sulfur hexafluoride. Tetrafluoromethane, hexafluoroethane and the aforementioned sulfur hexafluoride are particularly critical, as these compounds can pass through molecular sieve adsorbers. Due to its similar boiling point, sulfur hexafluoride accumulates together with xenon (similar boiling point) and the other two components in the krypton.

The compounds mentioned are thermally very stable and are also difficult to remove catalytically or are broken down into likewise undesirable secondary products. Sulfur hexafluoride has similar physical properties to xenon and is therefore difficult to separate from it. Sulfur hexafluoride therefore follows xenon in the air separation process.

It is known from EP 0 863 375 A1 to purify a krypton-xenon concentrate and/or krypton and/or xenon in a solid sorbent containing phyllosilicates, wherein fluorine-and/or chlorine-containing impurities, in particular fluorocarbons, such as carbon tetrafluoride and/or sulfur hexafluoride, are removed from the krypton-xenon concentrate and/or the krypton and/or the xenon. The aforementioned impurities are irreversibly bound by the sorbent through chemisorption, but the sorption reaction produces carbon dioxide as a degradation product, and water vapor and oxygen are released from the sorbent. To remove the carbon dioxide and water, subsequent adsorption steps are therefore required.

The object of the present invention is to improve corresponding methods for obtaining xenon, in particular by an effective and cost-effective removal of sulfur hexafluoride from the process.

### DISCLOSURE OF THE INVENTION

This object is achieved by a method and a system having the features of the independent claims. Embodiments of the invention are specified in the dependent claims and the description below.

The present invention provides a method for obtaining xenon, wherein a first feed flow containing xenon and sulfur hexafluoride is supplied to a rectification step, and a first subsequent flow is formed by means of the rectification step, said subsequent flow containing xenon and being enriched with sulfur hexafluoride in comparison with the first feed flow, wherein a second feed flow is formed using at least a part of the first subsequent flow, wherein the second feed flow is subjected to an adsorption step, and a second subsequent flow is formed by means of the adsorption step, said second subsequent flow containing xenon and being depleted of sulfur hexafluoride in comparison with the feed mixture.

As is common in technical language, the term “adsorption” in this application refers to physical adsorption (also called physisorption), i.e., a process that is based solely on physical processes. This excludes, in particular, chemical processes for sorption, such as chemisorption and getters. Getters and other chemisorbents differ from adsorbents in particular in that they bind the sorbed substances very strongly. In contrast to adsorbents, they cannot be regenerated in the process but must be exchanged after use.

The method proposed here comprises a (cryogenic) rectification separation stage, to which xenon containing sulfur hexafluoride (the “first feed flow”) is supplied and in which the slightly lighter xenon is recovered as overhead gas. In the rectification separation, a mixture of a few volume percent of sulfur hexafluoride in xenon is obtained as bottom liquid (using which the “first subsequent flow” is formed).

In the context of the present invention, for example, the content of sulfur hexafluoride in the first feed flow can be from 20 Vppm (parts per million by volume) to 300 Vppm or 50 Vppm to 150 Vppm and in the bottom liquid from 1 to 10 or 2 to 4 volume percent. In particular, the overhead gas can contain less than 10 Vppm or less than 1 Vppm of sulfur hexafluoride. The first feed flow, the bottom product and the overhead gas are in particular free or substantially free of other components, such as in particular krypton and oxygen, i.e., they contain at most 1 Vppm of such other components. However, the bottom product does not have to be free of krypton and oxygen, since it can be fed in again upstream in the process after the removal of sulfur hexafluoride.

To obtain pure xenon, the bottom liquid or a part of it can be continuously withdrawn and discarded. Alternatively, the bottom liquid can also be drained discontinuously and treated in the adsorption process. Both methods prevent sulfur hexafluoride from accumulating in the circuit. However, this causes a continuous loss of xenon because the bottom liquid also contains xenon. In principle, getters could be used for this purpose, on which sulfur hexafluoride is completely absorbed, but the concentrations of sulfur hexafluoride required for this are relatively high. Pure combustion of sulfur hexafluoride is not possible because various degradation products (sulfur, fluorine and oxygen species) would contaminate the xenon.

In this context, the present invention provides a possibility for increasing the yield of xenon in the production of pure xenon or the production of high-purity krypton and xenon, which proves to be significantly advantageous in particular in comparison with the solution explained at the beginning with reference to EP 0 863 375 A1. By dispensing with chemisorption, which can also be used in principle, the solution proposed according to the invention can be implemented more simply in terms of construction and operation.

In a first variant of the invention, the adsorption step is carried out using an adsorbent on which xenon is retained more strongly than sulfur hexafluoride, wherein the second subsequent flow is formed during a desorption phase in which the adsorbent is purged using a purge gas flow. In particular, the adsorption step is carried out using a molecular sieve, the pore size of which is selected such that xenon, but not the much larger sulfur hexafluoride, can enter it and is thus retained therein.

These embodiments therefore comprise the use of an in particular commercially available adsorbent, the pores of which are too small for the adsorption of the relatively large molecule sulfur hexafluoride, e.g. molecular sieve 5A. Xenon can be retained well therein, whereas sulfur hexafluoride can pass through the adsorbent substantially without retention. The adsorbent fills with xenon until it breaks through at the outlet. As a stronger adsorbate, xenon completely expels the very weakly adsorbing sulfur hexafluoride from its adsorption sites, i.e., in the event of a xenon breakthrough, the adsorbent is practically free of sulfur hexafluoride. The same would also occur in the presence of nitrogen, oxygen, krypton or other weakly adsorbing gases: xenon accumulates in the adsorbent without these gases.

In corresponding embodiments of the invention, the purge gas flow can be provided during the desorption phase in particular at a temperature in a temperature range from 0 to 200° C., and the second feed flow can be supplied to the adsorption step in gaseous form and at a temperature in a temperature range from-100 to 30° C. or 0 to 20° C. A temperature increase during the desorption phase can also be dispensed with. In this case, however, more purge gas (e.g. nitrogen) is required.

In the context of the present invention, it was surprisingly recognized that the temperature of the second feed flow is of secondary importance for the performance of the adsorption; rather, the temperature of the adsorption bed at the beginning of the adsorption phase is of decisive importance for the resulting temperature equilibrium. Therefore, according to one embodiment of the invention, precooling of the filling, for example to approx. 5° C., is desirable in order to increase the adsorption capacity. In a corresponding embodiment of the invention, the adsorbent is therefore precooled before an adsorption phase.

In corresponding embodiments of the invention, the adsorbent serves as temporary storage for xenon gas, which can later be desorbed by means of a corresponding purge gas flow, in particular at higher temperature and low pressure. The purge gas flow can be, for example, an oxygen-rich raw krypton-xenon flow, which is used to feed noble gas production. In this way, xenon can be reintroduced into the production process with almost no fractions of sulfur hexafluoride. Such a flow can be fed into the process in particular upstream of a catalytic methane removal stage or shortly thereafter, but in particular before existing molecular sieve adsorbers for carbon dioxide removal and drying, i.e., the desorption gas or the second subsequent flow is fed into the warm part of the production system, i.e., a part of a corresponding system that is operated at temperatures above 0° C.

In corresponding embodiments of the invention, the purge gas flow predominantly contains nitrogen. (Alternatively, a purge gas flow containing krypton, xenon and oxygen can be used.) In any case, the purge gas flow leaves the adsorber together with the desorbed xenon as a second subsequent flow. The second subsequent flow can, as also mentioned, be subjected to a krypton-xenon separation, wherein the first feed flow is formed using the krypton-xenon separation.

Xenon contaminated with sulfur hexafluoride from the column bottom can flow either continuously or discontinuously through the adsorbent to be used. For example, xenon contaminated with sulfur hexafluoride can be slowly introduced into a storage vessel and later removed from it at a different flow rate and fed into the adsorbent, which retains xenon but allows sulfur hexafluoride to pass through. In corresponding embodiments of the present invention, a xenon breakthrough at the end of adsorption can be analytically monitored in the adsorption step.

In embodiments of the invention, an auxiliary flow of poorly adsorbing gas (e.g. nitrogen) can be used during adsorption and desorption in order to maintain a measurable flow in the adsorber. The formation of the second feed flow and the formation of the purge gas flow can therefore comprise the addition of an auxiliary gas flow which contains at least one gas which adsorbs more poorly than xenon in the adsorption step, in particular nitrogen. In other words, nitrogen can therefore be added to the adsorber during both the adsorption phase and the desorption phase. This nitrogen passes into the second subsequent flow and can be separated therefrom comparatively easily in a rectification stage, into which the second subsequent flow is fed back.

The amount of the addition can be 0.5 to 5 times the xenon flow, i.e., the first subsequent flow or a part used by it, or the auxiliary gas flow can be added to the first subsequent flow or to the part thereof used to form the second feed flow in an amount which corresponds to 0.5 to 5 times the first subsequent flow or the said part.

At low sulfur hexafluoride contents of the order of 2%, the adsorber would experience almost no outlet flow, since only sulfur hexafluoride exits. This could create the risk of backmixing from downstream processes. This is avoided by the aforementioned addition.

The desorption gas, i.e., the second subsequent flow, can be transferred to a storage balloon, which absorbs all the noble gas-rich residual gases arising during the fine cleaning process. The contents can then be fed back into the process upstream, if necessary using a compressor or blower.

In the context of the present invention, the adsorption step can generally be carried out using adsorption vessels with a vessel diameter of, for example, 0.6 meters and a filling height of 1.5 meters, if necessary with a safety margin of 0.5 meters. By means of the aforementioned application of nitrogen, the second feed flow can be provided, for example, at 6 standard cubic meters per hour and with a content of 33% xenon and the remainder nitrogen and sulfur hexafluoride. Its temperature can be, for example, 15 to 25° C., in particular approx. 20° C., and its pressure 1.3 to 1.7 bar absolute pressure, in particular approx. 1.5 bar absolute pressure. In this case, with a charging time of 4 hours, approximately 8 standard cubic meters of xenon can be stored. Regeneration can be carried out, for example, at 4 standard cubic meters of nitrogen per hour, i.e., with an unchanged amount of nitrogen, for example for approx. 10 hours. No heating of the nitrogen is necessary.

A corresponding embodiment of the invention therefore comprises passing a first amount of nitrogen, which is introduced via the auxiliary gas flow, over the adsorbent during the adsorption phase in a first time interval with the first feed flow and passing a second amount of nitrogen, which is introduced via the auxiliary gas flow, over the adsorbent during the desorption phase in a second time interval with the purge gas flow. Advantageously, the first and second amounts of nitrogen do not differ by more than 10% or are substantially identical.

In a specific embodiment, the second feed flow is supplied to the adsorber discontinuously. For example, a collection in the column bottom lasting several months to one year is followed by an adsorption phase of approximately one day. After the end of the adsorption phase, nitrogen is fed into the adsorber as purge gas, and desorption begins. The desorption time is of the same order of magnitude but slightly longer than the adsorption time. This means that adsorption/desorption can be carried out using a single vessel—in contrast to the illustration in the drawing.

In a second variant of the present invention, the adsorption step is carried out using an adsorbent on which xenon is retained more weakly than sulfur hexafluoride. In these embodiments, the second subsequent flow is formed during an adsorption phase by the non-adsorbing xenon.

In other words, sulfur hexafluoride is retained on an adsorbent together with other well-adsorbing impurities, such as nitrous oxide and carbon dioxide, whereas xenon breaks through much earlier. Such a solution advantageously comprises an adsorber pair, which alternately adsorbs and is then thermally regenerated. The exiting xenon can in particular be condensed into a storage vessel until sulfur hexafluoride appears at the adsorber outlet. The more strongly adsorbing sulfur hexafluoride expels xenon almost completely from its adsorption sites, i.e., the xenon loss is low at the end of the adsorption cycle. The breakthrough of sulfur hexafluoride is advantageously monitored analytically.

As already explained in other words, the adsorption step can therefore be carried out using a molecular sieve, the pore size of which is selected such that sulfur hexafluoride can enter it.

In all variants of the invention, the adsorption process will preferably be carried out discontinuously in only a single vessel (batch process), as already explained above and described in claim 14. Alternatively, the adsorbent can be accommodated in two or more adsorber vessels, which are operated in a staggered manner in the adsorption/desorption phase.

The present invention also relates to a system for obtaining xenon. This is designed to supply a first feed flow containing xenon and sulfur hexafluoride to a rectification step, to form a first subsequent flow by means of the rectification step, said subsequent flow containing xenon and being enriched with sulfur hexafluoride in comparison with the first feed flow, to form a second feed flow using at least a part of the first subsequent flow, to subject the second feed flow to an adsorption step, and to form a second subsequent flow by means of the adsorption step, said second subsequent flow containing xenon and being depleted of sulfur hexafluoride in comparison with the feed mixture.

For features and advantages of a corresponding system, reference is expressly made to the above explanations relating to the method according to the invention and the embodiments thereof. The same applies, mutatis mutandis, to a system according to an embodiment of the invention which is designed to carry out a corresponding method and any embodiments thereof.

The invention is explained further below with reference to the accompanying drawings, which illustrate embodiments of the invention.

### DESCRIPTION OF THE FIGURES

FIG. 1 illustrates a method 100 for producing xenon according to an embodiment of the invention.

If subsequent method steps (e.g. a “rectification step”) are explained, the corresponding explanations also apply to corresponding system components (e.g. a “rectification column”), and vice versa. For the sake of clarity, a repeated explanation is omitted, and the same reference signs are used in some cases.

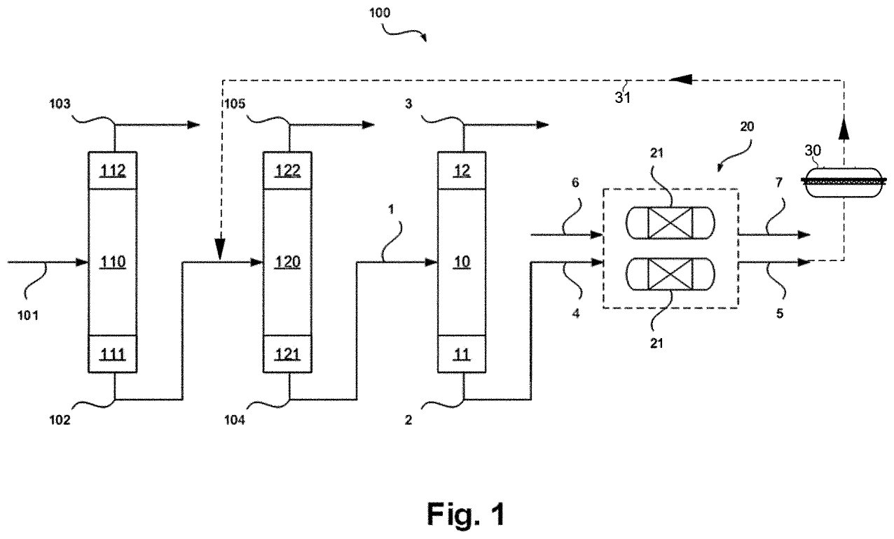

In the drawing, in the method 100, three rectification steps 110, 120 and 10 are shown extremely schematically as rectification columns, each with a bottom reboiler 111, 121 and 11 and a top condenser 112, 122 and 12. Each of the rectification steps 110, 120 and 10 also comprises the associated heat exchangers, lines, valves and vessels, even if these are not shown in FIG. 1. The rectification steps 110, 120 and 10 can also internally comprise more than one column, for example two to five columns. They can be located in the same place, but at least some of them are usually located in different places. An intermediate product is transported therebetween, for example in a gas cylinder or a liquid vessel. None of this is shown in the simplified drawing. A first rectification step (C1), which is not shown in the drawing, is often directly integrated into a cryogenic air separation system. Its product is generally stored in a liquid tank and transported from time to time by tanker to the location of the rectification step 110 (C2). Here, liquids from multiple C1 systems are usually collected and further processed. As the quantities processed are becoming increasingly smaller, one C3 system is often sufficient for a relatively large geographical area, for example a medium-sized European country, in which system all C2 products are collected and further processed. The rectification column 110 is operated as a separation device for oxygen, and the rectification column 120 is operated as a separation device for xenon and krypton.

In the rectification column 110, oxygen is separated out overhead into an overhead flow 103 from a precooled raw mixture 101, which can contain, for example, 5,000 ppm of krypton and xenon in oxygen, so that a bottom flow 102 of the rectification column 110 substantially contains krypton and xenon with the impurities explained above. In contrast, a krypton-rich fraction and a xenon-rich fraction are formed in the rectification column 120, so that an overhead flow 105 containing substantially krypton and impurities and a bottom flow 104 containing substantially xenon with, for example, approximately 100 ppm sulfur hexafluoride can be withdrawn from the rectification column 120. The overhead flow 105 can be passed to a further cleaning step, which is not separately illustrated here since it is not necessarily the subject matter of the invention.

The krypton and xenon-containing raw mixture 101, which as mentioned still contains a predominant proportion of oxygen, can be, for example, a raw mixture, which has been appropriately concentrated and freed from at least hydrocarbons, nitrous oxide and carbon dioxide, from an air separation system. The raw mixture 101 can, for example, be conducted through a deoxo stage and a dryer and pass through a heat exchanger (not shown here) in which it is cooled in countercurrent to a cold flow, for example the oxygen flow or overhead flow 103 from the first rectification column 100. The feed does not have to take place in the middle of the rectification column 110.

The rectification columns illustrated in FIG. 1 can be designed as structured packed columns or randomly packed columns. The first rectification column 110 can, for example, be operated at a pressure in a range of 1.5 to 5 bar (abs.).

The top condenser of the rectification column 110 can, for example, be operated with a liquid cryogenic coolant. This is typically liquid nitrogen, liquid oxygen, liquid argon, or mixtures thereof.

The feed into the rectification column 120 also does not necessarily have to take place in the middle. The operating pressure of the rectification column 120 can be 0.5 to 4 bar below the explained pressure of the rectification column 110.

The material flow 104 can be used in particular to form a first feed flow 1, to which reference has already been made many times above.

The material flow 1 is supplied to a rectification step 10 or the corresponding rectification column.

By means of the rectification step 10 or in a corresponding rectification column, a material flow 2 is formed using bottom liquid, which material flow is referred to here as the first subsequent flow, contains xenon and is enriched with sulfur hexafluoride in comparison with the first feed flow 1. Furthermore, a pure xenon flow 3, which is substantially freed from sulfur hexafluoride in the rectification stage, is formed using overhead gas.

Part of the method 100 is an adsorption step 20, which in the example shown here is carried out using adsorber vessels 21, 22 which each contain the same adsorption material and are operated alternatingly, as is generally known from the field of adsorption technology and therefore not shown in detail here. A material flow 4, referred to here as the second feed flow, is supplied to the adsorption step 2 and is formed using at least a part of the first subsequent flow 2. The second subsequent flow 5 contains xenon and is depleted of sulfur hexafluoride in comparison with the second feed flow 4. It can be fed back into the method 100 upstream.

In embodiments of the first variant of the invention, the second subsequent flow 5 is formed during a desorption phase in which the adsorbent is purged using a purge gas flow 6. This is the case when the adsorption step 20 is carried out using a molecular sieve, the pore size of which is selected such that xenon, but not sulfur hexafluoride, can enter it. In this case, the purge gas flow 6 can contain krypton, xenon and oxygen, and the second subsequent flow 5 can then comprise at least a part of the purge gas flow 6. In such embodiments, during an adsorption phase, a material flow enriched with sulfur hexafluoride will be formed as a third subsequent flow 7, which flows out of the adsorption material in question. This is removed from the method, for example by being discarded.

The second subsequent flow 5 is fed back into the method, for example by being introduced into a storage balloon 30. Further residual gases which still contain krypton or xenon in quantities that are worth processing can be introduced into this balloon. They can come from any step of the overall system 100, in particular from the third rectification step 10. The largely unpressurized gas 31 from the balloon 30 is fed back-if necessary by means of a blower-to the inlet of the rectification stage 110, in particular before a warm pretreatment at the inlet of the C2 stage. The corresponding amount of xenon is retained for obtaining product.

However, it is also possible, according to the second variant of the invention, to form the subsequent flow 5 during an adsorption phase, specifically in those embodiments in which the adsorption step 20 is carried out using an adsorbent on which xenon is retained more weakly than sulfur hexafluoride. The adsorption step 20 is carried out using a molecular sieve, the pore size of which is selected such that sulfur hexafluoride can enter it. In this case, a purge gas flow 6 is fed in during a desorption phase, which purge gas flow desorbs the sulfur hexafluoride and transfers it into a material flow 7.

1. A method for obtaining xenon, wherein a first feed flow containing xenon and sulfur hexafluoride is supplied to a rectification step, wherein a first subsequent flow is formed by means of the rectification step, said first subsequent flow containing xenon and being enriched with sulfur hexafluoride in comparison with the first feed flow, wherein a second feed flow is formed using at least a part of the first subsequent flow, wherein the second feed flow is subjected to an adsorption step, and a second subsequent flow is formed by means of the adsorption step, said second subsequent flow containing xenon and being depleted of sulfur hexafluoride in comparison with the second feed flow.

2. The method according to claim 1, wherein a third subsequent flow is also formed by means of the adsorption step, said third subsequent flow being enriched with sulfur hexafluoride in comparison with the second feed flow.

3. The method according to claim 2, wherein the third subsequent flow is removed from the method.

4. The method according to claim 1, wherein the adsorption step is carried out using an adsorbent on which xenon is retained more strongly than sulfur hexafluoride, and wherein the second subsequent flow is formed during a desorption phase in which the adsorbent is purged using a purge gas flow.

5. The method according to claim 4, wherein the adsorption step is carried out using a molecular sieve, the pore size of which is selected such that xenon, but not sulfur hexafluoride, can enter it.

6. The method according to claim 4, wherein the purge gas flow is provided during the desorption phase at a temperature in a temperature range of 50 to 200° C., and wherein the second feed flow is supplied to the adsorption step in gaseous form and at a temperature in a temperature range of −100 to 30 ° C. or −50 to 0° C.

7. The method according to claim 4, wherein the adsorbent is precooled before an adsorption phase.

8. The method according to claim 4, wherein the purge gas flow predominantly contains nitrogen.

9. The method according to claim 1, wherein the second subsequent flow is subjected to a rectification step for krypton-xenon separation, and the first feed flow is formed using the rectification step for krypton-xenon separation.

10. The method according to claim 4, wherein the formation of the second feed flow and the formation of the purge gas flow comprise the addition of an auxiliary gas flow which contains at least one gas which adsorbs more poorly than xenon in the adsorption step, in particular nitrogen.

11. The method according to claim 8, wherein the auxiliary gas flow is added to the first subsequent flow or to the part thereof used to form the second feed flow in an amount which corresponds to 0.5 times to 5 times the first subsequent flow or the part thereof.

12. The method according to claim 1, wherein the adsorption step is carried out using an adsorbent on which xenon is retained more weakly than sulfur hexafluoride.

13. The method according to claim 12, wherein the adsorption step is carried out using a molecular sieve, the pore size of which is selected such that sulfur hexafluoride can enter it.

14. The method according to claim 4, wherein the adsorbent is contained in a single adsorber vessel, and the second feed flow is collected and the adsorber vessel is operated in the adsorption phase and desorption phase in a staggered manner.

15. A system for obtaining xenon, which is designed to supply a first feed flow containing xenon and sulfur hexafluoride to a rectification step, to form a first subsequent flow by means of the rectification step, said subsequent flow containing xenon and being enriched with sulfur hexafluoride in comparison with the first feed flow, to form a second feed flow using at least a part of the first subsequent flow, to subject the second feed flow to an adsorption step, and to form a second subsequent flow by means of the adsorption step, said second subsequent flow containing xenon and being depleted of sulfur hexafluoride in comparison with the feed mixture.
